(19) United States
(12) Patent Application Publication
(10) Pub. No.: US 2023/0191420 A1
(43) Pub. Date: Jun. 22, 2023

(54) WASTE SEPARATOR APPARATUS

(71) Applicant: ECOMADE ENGINEERING S.R.L., Este (IT)

(72) Inventor: Daniele FORMAGGIO, Este PD (IT)

(21) Appl. No.: 17/996,376

(22) PCT Filed: Apr. 15, 2021
(86) PCT No.: PCT/IB2021/053101

§ 371 Date: Oct. 17, 2022

(30) Foreign Application Priority Data
Apr. 16, 2020 (IT) 102020000008065

(51) Int. Cl. B02C 18/14; B02C 18/00

(52) U.S. Cl. CPC B02C 18/146; B02C 18/0092; B02C 2018/162

(57) ABSTRACT

Waste separator apparatus which comprises: -a frame (11) which delimits a separation chamber (12); -a screening mesh (13) which divides the separation chamber (12) into a shredding chamber (121) and a collection chamber (122); wherein the shredding chamber (121) has a loading mouth (123) and an unloading mouth (124); - a shredder shaft (14) fixed to the frame (11) in a rotatable manner about an operating axis (A) and extending into the shredding chamber (121). The shredder shaft (14) has first cutting hammers (15) and second expelling hammers (16); wherein the screening mesh (13) faces the first hammers (15), in order to receive shredded material, and the discharging mouth (124) faces the second hammers (16). The second hammers (16) have a front edge (17) which is rectilinear and extends substantially parallel to a radial direction (C) with respect to the operating axis (A).

### TECHNICAL SECTOR

The present disclosure relates to a waste separator apparatus and more particularly a separator apparatus designed to separate material to be recycled, for example plastic material, from other materials together with which it is mixed.

### PRIOR ART

Plastic waste material, for example of domestic origin. often is mixed together with other solid materials and/or materials contaminated with organic material, which is difficult to eliminate.

This occurs in particular in the case of plastic films used to package food products or used to form bags inside which the waste is collected and enclosed. In order to allow recycling of the waste fraction composed of plastic material, the waste is treated in special machines, or separator apparatus, which crush the waste, comminuting the plastic products, such as bags and/or containers, reducing them to shreds.

Efficient comminution of the plastic products allows efficient washing of the shreds obtained and consequently suitable removal in particular of the organic residues.

Therefore there is a pressing need for separator apparatus able to perform efficient comminution and separation of the plastic material from the remaining overscreen waste.

In the sector it is known that the main problems relating to the shredding and separation of the waste are due mainly to the heterogenous composition of the said waste, i.e. both the type of material which it comprises and the form which it has.

In fact the waste may comprise materials with a considerable hardness which could damage the separator apparatus and, at the same time, materials which may fray easily, thus resulting in the risk of becoming entangled with the movable parts of the separator apparatus, causing possible clogging thereof.

A separator apparatus which is known nowadays comprises a frame which defines a separation chamber inside which a shredder shaft and a screening mesh are mounted.

The screening mesh divides the separation chamber into a shredding chamber and a collection chamber.

The shredder shaft extends along an operating axis between two longitudinal ends of the shredding chamber.

The frame is also provided with a loading mouth and a discharging mouth, which are located at the opposite ends of the shredding chamber.

In particular, the loading mouth is located underneath an end section of the shredder shaft, while the remainder of the shredder shaft extends above the screening mesh.

The shredder shaft comprises a core to which a plurality of hammers which extend radially with respect to the operating axis are fixed.

A first group of these hammers have a cutting edge facing in a direction circumferential to the operating axis and directed in the direction of the rotation of the shredder shaft.

In other words, when the shredder shaft is active, rotating in its direction of rotation, the blades move following a circumferential path around the operating axis of the shredder shaft so as to cut the material which they encounter.

A second group of these hammers have, instead of the cutting edge, a convex profile which faces, in a direction circumferential to the operating axis, the direction of the rotation of the shredder shaft.

These second hammers have a thickness, along a direction circumferential to the operating axis, which increases in the radial direction with respect to the latter such that the end which is remote from the operating axis defines a cusp which, when the shredder shaft is rotating, in said direction of rotation, precedes the remainder of the second hammer.

The first hammers have a substantially wedge-shaped, asymmetrical, cross-section oriented, with respect to a direction circumferential to the operating axis, so that when the shredder shaft is rotating in said direction of rotation, material which is introduced through the loading mouth is pushed longitudinally with respect to the operating axis towards the discharging mouth.

In other words, the first hammers at the same time shred the material introduced into the shredding chamber and push it towards the discharging mouth.

The shredding chamber and the shredder shaft extend so as to be situated above both the screening mesh and the discharging mouth, such that, during operation, material which crosses the shredding chamber, entering via the loading mouth and directed towards the discharging mouth, first passes along the screening mesh and then reaches the discharging mouth.

The second hammers are present along the end section of the shredding shaft such as to be situated above the discharging mouth and prove to be particularly effective at picking up frayed material at the cusp and then expelling it through the discharging mouth.

### SUMMARY

Studies carried out by the Applicant lead to the conclusion that a conventional separator apparatus, as described above, although viewed very positively, may be improved.

In particular the problem forming the basis of the present invention is to improve the productivity of a conventional separator apparatus.

The task of the separator apparatus according to the present invention is therefore that of solving this problem.

In connection with this task an object of the invention is to propose a separator apparatus which is able to reduce the risk of material being retained inside the shredding chamber.

Another object of the invention is to provide a separator apparatus which is able to prevent or limit the entanglement of frayed bodies inside the shredding chamber.

A further object of the invention is to propose a separator apparatus which is able to reduce the risk of entanglement of products on the shredder shaft.

Yet another object of the invention is to provide a separator apparatus which is able to optimize simultaneously the shredding effect and the rapid expulsion from the shredding chamber of the shredded or frayed material.

This task, as well as these and other objects, which will become clearer below, are achieved by a waste separator apparatus according to the attached claim 1. Detailed characteristic features of a waste separator apparatus, according to the invention, are contained in the dependent claims.

Further characteristic features and advantages will emerge more clearly from the description of a preferred, but non-exclusive embodiment of a waste separator apparatus according to the invention, illustrated in an embodiment illustrated solely by way of a non-limiting example in the attached sets of drawings listed below.

### BRIEF DESCRIPTON OF THE DRAWINGS

FIG. 1 shows a meridian sectioned view of a waste separator apparatus according to the present invention;

FIG. 2 shows a perspective view of a detail of the shredder shaft of the waste separator apparatus according to FIG. 1;

FIG. 3 shows a meridian sectioned view of a variant of the shredder shaft according to FIG. 2.

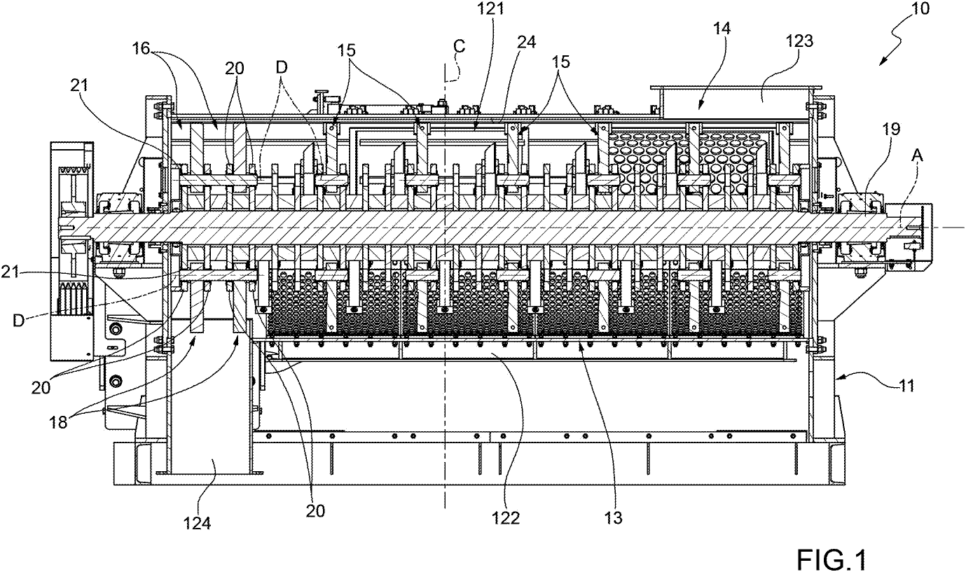

### DETAILED DESCRIPTION

With particular reference to the said figures, 10 denotes overall a waste separator apparatus which comprises:
a frame 11 which delimits a separation chamber 12;
a screening mesh 13 which divides the separation chamber 12 into a shredding chamber 121 and a collection chamber 122;
a shredder shaft 14 fixed to the frame 11 in a rotatable manner about an operating axis A.

The shredder shaft 14 has first cutting hammers 15 and second expelling hammers 16; wherein the screening mesh 13 faces the first hammers 15 in order to receive shredded material.

The separation chamber 12 and preferably the shredding chamber 121 has a loading mouth 123 and a discharging mouth 124 and the shredder shaft 14 extends into the shredding chamber 121 between the loading mouth 123 and the discharging mouth 124.

The discharging mouth 124 faces the second hammers 16 of the shredder shaft 14 in order to receive material expelled from the shredding chamber 121.

In a manner conventional per se the first hammers 15 may have a substantially wedge-shaped, asymmetrical, cross-section oriented, with respect to a direction circumferential to the operating axis A, so that when the shredder shaft 14 is rotating in a predefined direction of rotation C, material which is introduced through the loading mouth 123 is pushed longitudinally with respect to the operating axis A towards the discharging mouth 124 by the action of the first hammers 15.

In other words, the first hammers 15 may be configured so that, during operation, at the same time they shred the material introduced into the shredding chamber 121 and push it towards the discharging mouth 124.

The shredding chamber 12 and the shredder shaft 14 may extend so as to face both the screening mesh 13 and the discharging mouth 124 such that, during operation, material which crosses the shredding chamber 121, entering via the loading mouth 123 and directed towards the discharging mouth 124, first passes along the screening mesh 13 and then reaches the discharging mouth 124.

Structurally speaking, the screening mesh 13 may extend along the operating axis A from a first end of the crushing chamber 121 as far as the discharging mouth 124 which extends along the operating axis A as far as a second end of the shredding chamber 121, opposite to the first end.

The frame 11 defines a surface for resting on the ground, for example by means of its own base, and may be configured so that, when the waste separator apparatus 10 is resting on this support surface, the screening mesh 13 and/or the discharging mouth 124 may be located underneath the shredder shaft 14, and the loading mouth 123 may be located above the shredder shaft 14.

In this way, the material shredded by the shredder shaft 14 may cross the screening mesh 13 by means of gravity.

The shredder shaft 14 may have, along the operating axis A, a first section and thereafter a second section.

The second hammers 16 may be all exclusively present along the second section of the shredder shaft 14.

This second section may face the discharging mouth 124 such that the second hammers 16 may face and be optionally located above the discharging mouth 124.

A waste separator apparatus 10 according to the present invention has the second hammers 16 which have a front edge 17 which is rectilinear and extends substantially parallel to a radial direction C with respect to the operating axis A.

The expression “substantially”, referring to the parallel condition, in the present text is understood meaning that two directions which have a mutual inclination not greater than 30° and preferably not greater than 10° satisfy this condition of substantially parallelism.

Differently from the widespread views held in the present sector regarding the validity of the waste separator apparatus described in the introduction, in particular with regard to the fact that the second hammers are provided with a cusp at their end remote from the shredder shaft, the Applicant has surprisingly discovered that the second hammers 16 of the waster separator apparatus 10 according to the present invention, since they have the front edge 17 which is rectilinear and parallel to the radial direction C, are particularly effective in obtaining a combined waste shredding and expulsion effect while at the same time facilitating the extraction of fibrous or frayed material from the said second hammers.

In other words, a waste separator apparatus 10, according to the present invention, is able to reduce greatly the risks of clogging and increase productivity.

The second hammers 16 may be organized in groups 18 arranged side-by-side along the operating axis A.

The groups 18 may consist of a number of between 2 and 5 and each group 18 may comprise 3 to 8 of the second hammers 16 and preferably 4 hammers. The Applicant has surprisingly discovered that this organization offers an unexpected working efficiency which is able to ensure a high productivity of the waste separator apparatus 10 according to the present invention.

The second hammers 16 of each group 18 may be arranged at regular angular intervals around the operating axis A, in order to increase the action on the waste and limit the risk of clogging.

The aforementioned advantageous effects are unexpectedly increased if the front edge 17 of the first hammers 15 is chosen with a width, namely an extension along the operating axis A, which is substantially constant along a direction parallel to a radial direction C with respect to the operating axis A, where this width may be between 2 cm and 8 cm and preferably is 6 cm.

Successive groups 18 may be mutually spaced, along the operating axis A, at a distance of between 2 cm and 8 cm; where preferably said distance is equal to the length of second hammers 16.

This makes operation of the waste separator apparatus 10 unexpectedly efficient, optimizing the reduction of the risk of clogging and facilitating the expulsion of fibrous or frayed products, such as plastic bags, from the shredding chamber 121.

Structurally, the shredder shaft 14 may comprise a core 19 to which the first hammers 15 and/or the second hammers 16 are fixed in a tilting manner about auxiliary axes D which are parallel to the operating axis A.

In other words, the first hammers 15 and/or the second hammers 16 may therefore rotate with respect to the core 19 so as to be able to be even folded down onto it.

This provides the waste separator apparatus 10 with a high degree of operational flexibility, being able to adapt easily, without damage, in the event of large-size hard bodies being present inside the shredding chamber.

These bodies will in fact be repeatedly struck by the first hammers 15 and/or by the second hammers without these hammers, which remain fixed in relation to the core 19, being damaged or being able to cause rotation of these bodies.

In this case, the characteristic feature of the front edge 17 being substantially parallel to the radial direction C must be understood as occurring in a nominal operating condition of the waste separator apparatus 10, namely with respect to a condition of the second hammers 16 assumed when the shredding shaft 14 is rotating about the operating axis A, where the shredding chamber 121 is not occupied by waste, and the second hammers 16 assume, by means of a centrifugal action, a radial orientation with respect to the operating axis A.

Preferably all the hammers 15 and 16 are tilting with respect to the core 19; however, in some embodiments only some of the first hammers 15 and/or second hammers 16 may be tilting with respect to the core 19.

The shredder shaft 14 may comprise flanges 20 which are rigidly fixed to the core 19 and pins 21 which connect the first hammers 15 and/or the second hammers 16 to the flanges 20 so as to define the auxiliary tilting axes D for the first hammers 15 and/or the second hammers 16.

In this way the shredder shaft 14 is particularly simple to manufacture and maintain. In fact, in the case where one or more first hammers 15 and/or second hammers 16 are to be replaced, for example because they are worn or damaged, it will be sufficient to remove the pins 21 which connect them to the associated flanges 20 in order to remove them and, vice versa, perform the reverse operation in order to reassemble corresponding replacement hammers. The second hammers 16 may be connected by a single pin 21 to the corresponding flanges 20 for a simpler and more solid constructional design.

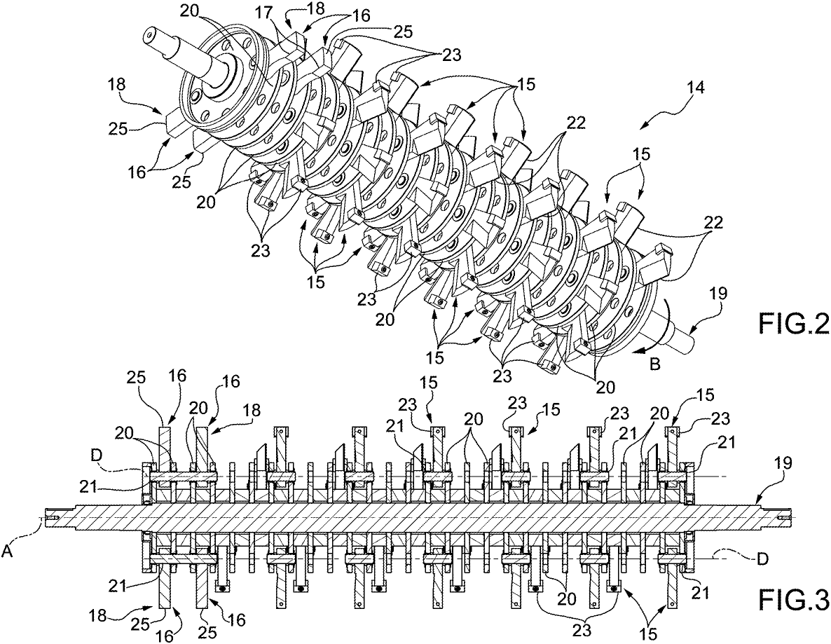

In other words, each pin 21 may connected to the flanges 20 a plurality of second hammers 16, as for example shown in FIG. 2.

The first hammers 15 may have a cutting edge 22 and a scraper 23.

The cutting edge 22 may extend at least mainly in a direction parallel to a radial direction C with respect to the operating axis A; whereby, in the case where the first hammers 15 are tilting, this characteristic feature of the cutting edge 22 being able to extend at least mainly in a direction parallel to a radial direction C must be understood as occurring in a nominal operating condition of the waste separator apparatus 10, namely in relation to a condition of the first hammers 15 assumed when the shredder shaft 14 is rotating about the operating axis A, where the shredding chamber 121 is not occupied by waste, and the first hammers 15 assume, by means of a centrifugal action, a radial orientation with respect to the operating axis A.

The frame 11 may have an internal wall 24 which together with the screening mesh 13 delimits a first section of the shredding chamber 121.

This first section of the shredding chamber 121 has a substantially cylindrical internal face coaxial with the operating axis A.

The scrapers 23 have a cutting edge and the first hammers 15 are configured in such a way that, during operation, the cutting edge of the scrapers 23 skims over the internal faces.

In this way, the efficiency of the first hammers 15 is greatly increased, preventing clogging of the screening mesh 13 owing to the scraping action of the scrapers 23.

The second hammers 16 have a radial end and are configured so that, during operation, they skim over an internal face of the shredding chamber 121 with their radial end so as to prevent the accumulation of waste inside the shredding chamber 121.

It has therefore been shown how a waste separator apparatus 10 according to the invention achieves the predefined task and objects, thereby reducing the risk of material being retained inside the shredding chamber.

Moreover, a waste separator apparatus according to the present invention is able to prevent or limit the entanglement of frayed bodies inside the shredding chamber and in particular on the shredder shaft.

With a waste separator apparatus according to the invention it is also possible to optimize simultaneously the effect of shredding and rapid expulsion from the shredding chamber of the shredded or frayed material.

The invention thus devised may be subject to numerous modifications and variations, all of which fall within the scope of protection of the attached claims. Moreover, all the details may be replaced by other technically equivalent elements.

In practice the materials used as well as the associated forms and dimensions may be varied depending on the particular requirements and the state of the art. Where the constructional characteristics and the techniques mentioned in the following claims are followed by reference numbers or symbols, these reference numbers or symbols have been assigned with the sole purpose of facilitating understanding of the said claims and consequently they do not limit in any way the interpretation of each element which is identified, purely by way of example, by said reference numbers or symbols.

1. A waste separator apparatus which comprises:
a frame (11) which delimits a separation chamber (12);
a screening mesh (13) which divides said separation chamber (12) into a shredding chamber (121) and a collection chamber (122); said shredding chamber (121) having a loading mouth (123) and a discharging mouth (124);
a shredder shaft (14) fixed to said frame (11) in a rotatable manner about an operating axis (A), and extending into said shredding chamber (121);
said shredder shaft (14) having first cutting hammers (15) and second expelling hammers (16); where said screening mesh (13) faces said first hammers (15), in order to receive shredded material, and said discharging mouth (124) faces said second hammers (16);
where said second hammers (16) have a front edge (17) which is rectilinear and extends substantially parallel to a radial direction (C) with respect to said operating axis (A).

2. The waste separator apparatus according to claim 1, wherein said second hammers (16) are arranged in groups (18) side-by-side along said operating axis (A); said groups (18) being between 2 and 5 in number and each of said groups (18) comprising 3 to 8 of said second hammers (16) and preferably 4 hammers.

3. The waste separator apparatus according to claim 2, wherein the second hammers (16) of each of said groups (18) are arranged at regular angular intervals around said operating axis (A).

4. The waste separator apparatus according to claim 2, wherein the front edge (17) of said first hammers (15) has a width, i.e. an extension along said operating axis (A), which is substantially constant along a direction parallel to a radial direction (C) with respect to said operating axis (A); said width being between 2 cm and 8 cm and preferably being 6 cm.

5. The waste separator apparatus according to claim 2, wherein successive groups (18) of said groups (18) are mutually spaced, along said operating axis (A), at a distance of between 2 cm and 8 cm; where preferably said distance is equal to the width of second hammers (16).

6. The waste separator apparatus according to claim 1, wherein said shredder shaft (14) comprises a core (19) to which said first hammers (15) and/or said second hammers (16) are fixed in a tilting manner about auxiliary axes (D) which are parallel to said operating axis (A).

7. The waste separator apparatus according to claim 6, wherein said shredder shaft (14) comprises flanges (20) rigidly fixed to said core (19) and pins (21) which connect said first hammers (15) and/or said second hammers (16) to said flanges (20) so as to define said tilting auxiliary axes (D) for said first hammers (15) and/or for said second hammers (16).

8. The waste separator apparatus according to claim 1, wherein said first hammers (15) have a cutting edge (22) and a scraper (23); said cutting edge (22) extending at least mainly in a direction parallel to a radial direction (C) with respect to said operating axis (A); said frame (11) having an internal wall (24) which with said screening mesh (13) delimits a first section of said shredding chamber (121); said first section having a substantially cylindrical internal face, coaxial with said operating axis (A); said scrapers (23) having a cutting edge and said first hammers (15) being configured in such a way that, during operation, the cutting edge of said scrapers (23) skim over said internal face.

9. The waste separator apparatus according to claim 1, wherein said second hammers (16) have a radial end and are configured so that, during operation, they skim over the internal face of said shredding chamber (121) with said radial end.
